(19) United States
(12) Patent Application Publication
(10) Pub. No.: US 2017/0120463 A1
(43) Pub. Date: May 4, 2017

(54) SPRING-ASSISTED UTILITY KNIFE

(71) Applicant: STANLEY BLACK & DECKER, INC., New Britain, CT (US)

(72) Inventors: Thomas PELLETIER, Wallingford, CT (US); Keith LOMBARDI, Avon, CT (US); Jo-Tung HUNG, Taichung City (TW)

(73) Assignee: STANLEY BLACK & DECKER, INC.

(21) Appl. No.: 15/343,175

(22) Filed: Nov. 3, 2016

Related U.S. Application Data
(60) Provisional application No. 62/250,730, filed on Nov. 4, 2015.

(51) Int. Cl. B26B 5/00

(52) U.S. Cl. CPC B26B 5/003

(57) ABSTRACT

A utility knife includes a folding handle in which a neck folds into a handle base. A neck lock locks the neck in its closed or open position relative to the handle base. The neck is spring-biased toward its open position to assist in one-handed opening of the handle. A utility blade and blade holder are slidably carried by neck for manual movement between retracted/protected and extended/exposed positions. The neck cannot be folded into or locked in the closed position if the blade is exposed.

### CROSS REFERENCE

This application claims the benefit of priority from U.S. Provisional Patent Application Ser. No. 62/250,730, filed Nov. 4, 2015, titled “SPRING-ASSISTED UTILITY KNIFE,” the entire contents of which are hereby incorporated by reference herein.

### BACKGROUND OF THE INVENTION

1. Field of the Invention

This invention relates to utility knives that can selectively expose or protect a cutting edge of a replaceable utility blade.

2. Description of Related Art

A conventional utility knife includes a handle with a blade holder slidably disposed within the handle. See, e.g., U.S. Pat. Nos. 4,242,795, 6,249,975. A utility blade detachably mounts to the blade holder. The standard blade has a cutting edge disposed on one edge and one or more mounting notches disposed on an opposite edge. When the blade holder is in a retracted position, the blade is disposed within and protected by the handle. When the blade holder is slid into an extended position, a portion of the blade becomes exposed for use.

### SUMMARY OF EMBODIMENTS OF THE INVENTION

One of more embodiments of the present invention provides a knife that includes: a handle base; a neck connected to the handle base for movement relative to the handle base between a closed position and an open position; a first spring that operatively extends between the handle base and neck to spring-bias the neck toward the neck's open position; a manually releasable neck lock that releasably locks the neck in closed position, wherein the neck lock is configured such that manually releasing the neck lock while the neck is in the closed position permits the neck spring to move the neck into the neck's open position; and a utility blade holder slidingly carried by the neck for sliding movement relative to the neck and handle base between a retracted position and an extended position. The utility blade holder is shaped and configured to carry a utility blade such that movement of the utility blade holder between its extended and retracted positions moves the utility blade relative to the neck and handle base between an exposed position in which a cutting edge of the blade is exposed, and a protected position in which the cutting edge of the blade is protected by the neck.

According to one or more embodiments, the knife includes the utility blade.

According to one or more embodiments, a surface of the handle base prevents the neck from moving into the closed position unless the utility blade is in the protected position.

According to one or more embodiments, a surface of the handle base prevents the neck from moving into the closed position while a cutting edge of the utility blade is exposed.

According to one or more embodiments, a surface of the handle base prevents the blade from moving out of the protected position while the neck is in the closed position.

According to one or more embodiments, the utility blade has a mounting notch formed in a first linear edge and a cutting edge opposite the first linear edge, and the utility blade substantially has the shape of an isosceles trapezoid, the cutting edge being disposed on a longest edge of the trapezoid.

According to one or more embodiments, the neck lock is configured to automatically lock the neck in the closed position upon movement of the neck into the closed position.

According to one or more embodiments, the neck lock includes: a detent movably mounted to one of the neck and handle base for movement between a locking position and a releasing position; and a lock closed surface disposed on the other of the neck and handle base. When the neck is in the closed position and the detent is in the locking position, the detent engages the lock closed surface to prevent the neck from moving out of the closed position.

According to one or more embodiments, the neck lock further includes a second spring that spring biases the detent toward its locking position, and the detent further includes a manually actuatable button that may be actuated by a user to move the detent from its locking position to its releasing position against the bias of the second spring, thereby permitting the first spring to move the neck into the neck's open position.

According to one or more embodiments, the neck lock is configured to automatically lock the neck in the open position upon movement of the neck into the open position, wherein the neck lock is configured to permit manual release of the neck lock while the neck is in the open position to permit a user to move the neck into the closed position.

According to one or more embodiments, the neck lock includes: a detent movably mounted to one of the neck and handle base for movement between a locking position and a releasing position; a lock open surface disposed on the other of the neck and handle base; and a second spring that spring biases the detent toward its locking position. When the neck is in the open position and the detent is in the locking position, the detent engages the lock open surface to prevent the neck from moving out of the open position. When the detent is in the releasing position, movement of the neck into the neck's open position causes the detent to move into the locking position under the spring bias of the second spring.

According to one or more embodiments, the knife includes a manually operable slide lock that releasably locks the blade holder in the extended position or the retracted position.

According to one or more embodiments, the neck pivotally connects to the handle base for pivotal movement relative to the handle base between the closed position and the open position.

According to one or more embodiments, the blade holder is movable between the blade holder's extended and retracted positions while the neck is in the neck's open position.

According to one or more embodiments, the neck's open position is a position in which the neck and handle base together define a longitudinally elongated handle that is shaped and configured for a user to grip the knife during use while the neck is in the open position.

According to one or more embodiments, a combined length of the handle base and neck when the neck is in the open position is 50%-90% longer than the combined length of the handle base and neck when the neck is in the closed position.

According to one or more embodiments, a combined length of the handle base and neck when the neck is in the closed position is between 2.5 and 5 inches, and a combined length of the handle base and neck when the neck is in the open position is between 5.5 and 9 inches.

One or more embodiments provide a method of using one or more embodiments of the knife. The method includes: manually releasing the neck lock of the knife while the neck is in the closed position, whereby said releasing causes the first spring to move the neck into the neck's open position; and while the neck is in the open position, sliding the utility blade holder from the retracted position to the extended position, thereby moving the utility blade from the protected position to the exposed position.

According to one or more embodiments, the method also includes manually releasing the neck lock while the neck is in the open position, and thereafter moving the neck from its open position to its closed position. The movement of the neck into its closed position causes the neck lock to lock the neck in its closed position.

According to one or more embodiments, a surface of the knife prevents the neck from being moved into the closed position unless a cutting edge of the blade is not exposed.

These and other aspects of various embodiments of the present invention, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification, the singular form of “a”, “an”, and “the” include plural referents unless the context clearly dictates otherwise.

All closed-ended (e.g., between A and B) and open-ended (greater than C) ranges of values disclosed herein explicitly include all ranges that fall within or nest within such ranges. For example, a disclosed range of 1-10 is understood as also disclosing, among other ranged, 2-10, 1-9, 3-9, etc.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIG. 1 is a left side view of a knife according to an embodiment, shown with the neck in a closed position;

FIG. 2 is a left side view of the knife of FIG. 1, shown with the neck in a closed position and with portions of the neck and handle base removed;

FIG. 3 is a bottom view of the knife of FIG. 1, shown with the neck in a closed position;

FIG. 4 is a left side view of the knife of FIG. 1, shown with the neck in an open position and a blade holder retracted;

FIG. 5 is a bottom view of the knife of FIG. 1, shown with the neck in an open position and the blade holder retracted;

FIG. 6 is a left side view of the knife of FIG. 1, shown with the neck in an open position and the blade holder and blade extended;

FIG. 7 is a left side view of the knife of FIG. 1, shown with the neck in an open position and the blade holder and blade extended, with a left half of the neck removed;

FIG. 8 is an exploded perspective view of the components of the knife of FIG. 1; and

FIG. 9 includes side views of various utility blades that may be used with the knives according to various embodiments.

### DETAILED DESCRIPTION OF EXEMPLARY EMBODIMENTS OF THE INVENTION

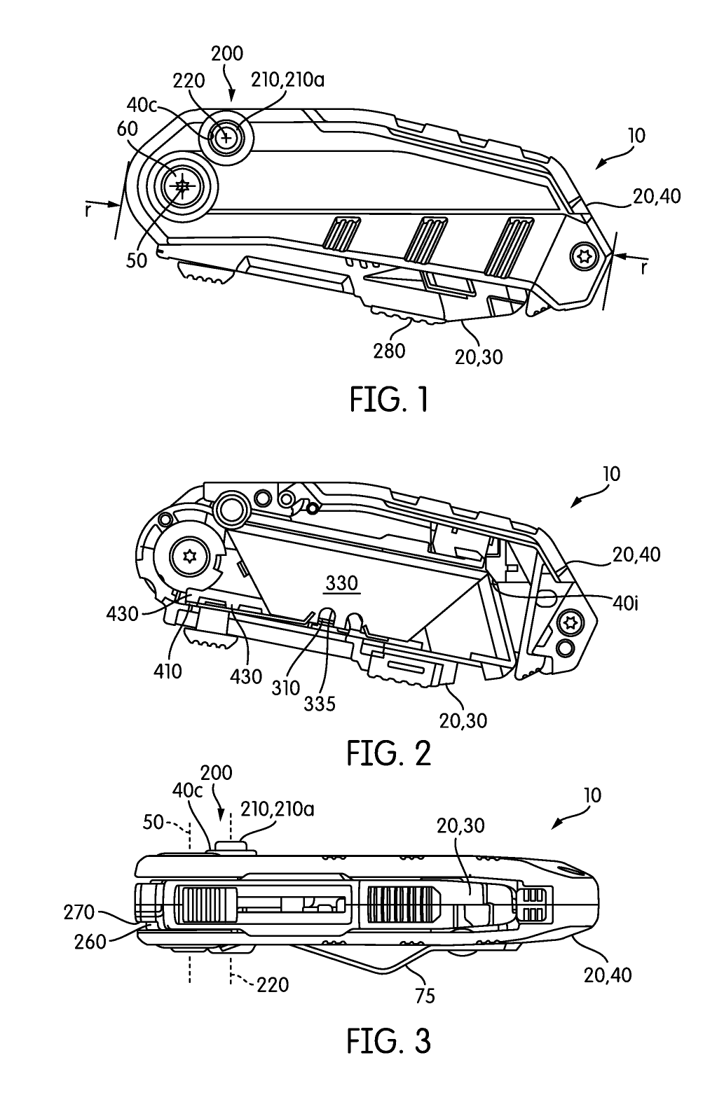

FIGS. 1-8 illustrate a utility knife 10 according to an embodiment of the present invention. The knife 10 includes a handle 20 formed by a neck 30 and a handle base 40, a neck lock 200, a sliding blade holder 300, a slide lock 400, and a blade-lock quick-release 500.

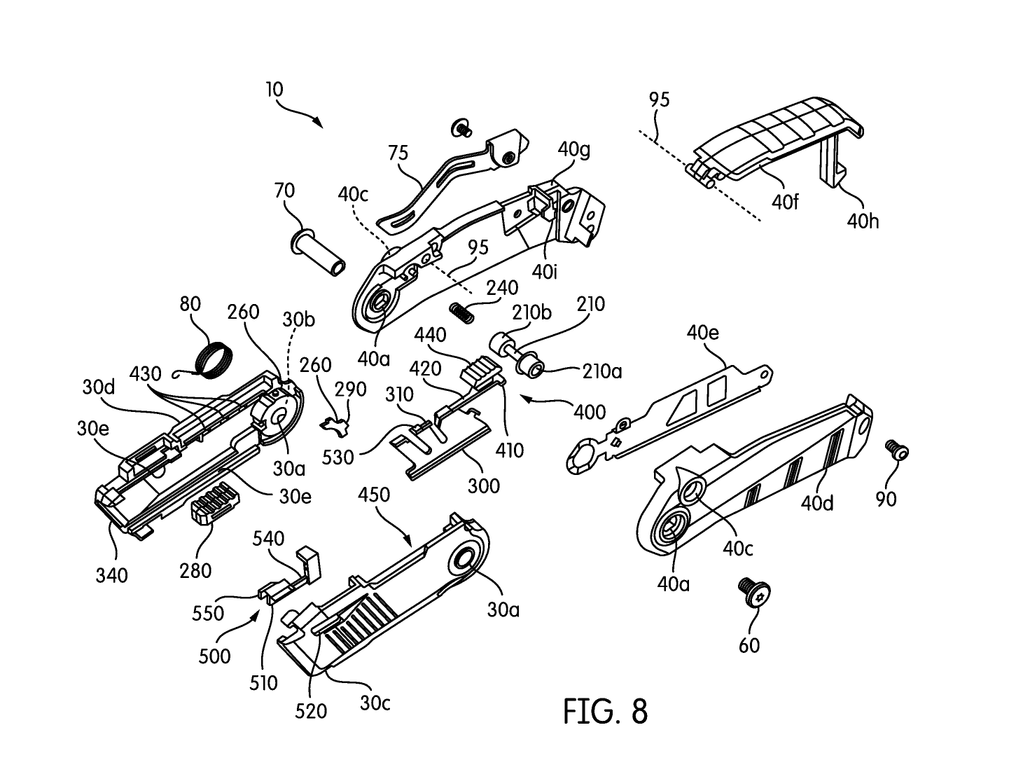

As shown in FIGS. 1, 2, 4, 5, and 12, the neck 30 pivotally connects to the handle base 40 for relative pivotal movement about an axis 50 via a bolt 60 and nut/bushing 70 that define an axle of the hinge. As shown in FIG. 8, the bolt 60 and/or nut/bushing 70 extend through holes 30a, 40a in the neck 30 and handle base 40, respectively. In the illustrated embodiment, the pivotal connection between the neck 30 and handle base 40 is defined by the bolt 60 and/or nut/bushing 70. However, according to alternative embodiments, any other type of pivotal connection may be used (e.g., an axle and collar, a living hinge, etc.) without deviating from the scope of the present invention.

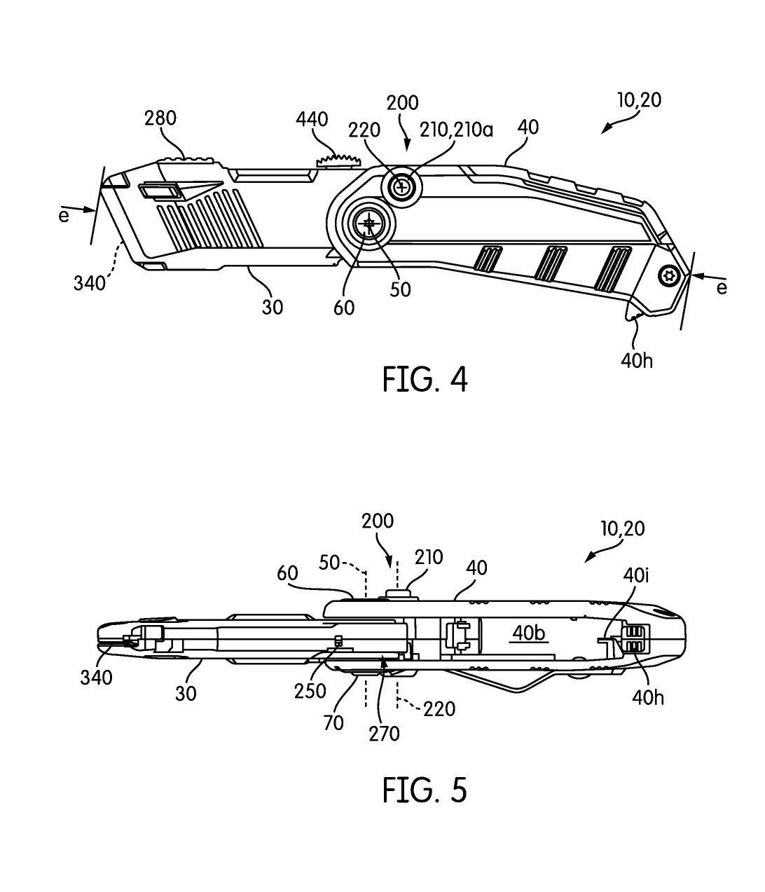

The handle base 40 has a hollow channel 40b (see FIG. 5) that is open on its lower side (as viewed when the knife is in the open position shown in FIGS. 4-7) such that the neck 30 can pivot about the axis 50 into and out of the hollow channel 40b of the handle base 40. Consequently, the neck 30 pivots relative to the handle base 40 between an open position (shown in FIGS. 4-7) and a closed position (shown in FIGS. 1-3). When the neck 30 is in the closed position, a majority of the neck 30 is disposed within the channel 40b of the handle base 40.

As shown in FIG. 8, the handle base 40 is formed by several components 40d, 40e, 40f, 40g that are held together by bolts 60, 90 and a nut 70. However, according to alternative embodiments, the handle base 40 is formed by a single integral component (e.g., a casting), for example as shown in U.S. Patent Application Publication No. 2010/0223793 A1, the handle base teachings of which are incorporated herein by reference. The handle base component 40f is a door 40f that pivotally connects to the remainder of the handle base 40 and includes a manually actuatable latch 40h that can be pressed/deformed to permit the door 40f to be opened (pivoted upwardly about an axis 95 (see FIG. 8). Handle base component 40e is an spare blade holder 40e that retains extra utility blade(s) inside the channel 40b. These extra blade(s) can be accessed by opening the door 40f According to various embodiments, the spare blades cannot be accessed via the channel 40b, but can only be accessed via the door 40f According to various embodiments, such limited access may help to avoid having extra blades accidentally dislodge from the blade holder 40e and fall out of the channel 40b.

As shown in FIGS. 3 and 8, an elastic belt clip 75 (e.g., plastic, stamped metal, etc.) is bolted to a side of the handle base 40.

As shown in FIG. 8, a neck spring 80 is disposed within an annular opening 30b in the neck 30 that is concentric with the axis 50. One operative end of the neck spring 80 abuts the neck 30, while the other operative end of the neck spring 80 abuts the handle base 40. As a result, the neck spring 80 operatively extends between the neck 30 and handle base 40 and is tensioned so as to spring-bias the neck 30 toward and into the open position (shown in FIGS. 4-7). In the illustrated embodiment, the neck spring 80 is a torsion spring. However, according to various alternative embodiments, any other suitable spring may be used (e.g., a linear spring, an elastically deformable structure (e.g., rubber band, magnet(s)), etc. that operatively extends between the neck 30 and handle base 40 so as to spring-bias the neck 30 toward its open position).

In the illustrated embodiment, the neck 30 and handle base 40 together form the handle 20 such that the handle 20 is long and comfortable for a user to grip when the neck 30 is in the open position, and a compact and easily storable when the neck 30 is in the closed position. However, according to alternative embodiments of the present invention, the handle base 40 alone defines the handle, and the neck 30 projects from the handle 20/handle base 40 without being part of the handle 20.

In the illustrated embodiment, when the neck 30 is in its open position, the neck 30 and handle base 40 generally extend linearly relative to each other to maximize an open length of the handle 20. However, according to alternative embodiments of the present invention, the neck 30 and handle base 40 may define an arc (e.g., “(” shape) or angle (e.g., “>” shape) when the neck 30 is in its open position.

As shown in FIGS. 1, 3, 5, and 8, the knife 10 also includes a neck lock 200 that selectively locks the neck 30 in either of the open and/or closed positions. As shown in FIGS. 1, 3-5, and 8, the neck lock 200 includes a detent 210 that is mounted to the handle base 40 for lateral axial movement relative to the handle base 40 along an axis 220 between a locking position (upwardly as shown in FIGS. 3 and 5) and a releasing position (downwardly as shown in FIGS. 3 and 5). The axes 50, 220 may be parallel to each other. As shown in FIG. 8, the detent 210 is captured within openings 40c in the handle base 40 so as to permit limited axial movement along the axis 220, while generally preventing movement in other translational directions and while preventing the detent 210 from detaching from the handle base 40 via movement all the way through one of the openings 40c. The right side opening 40c is a blind/closed opening 40c, while the left side opening 40c (shown in FIG. 1) is a through-hole.

As shown in FIG. 8, a neck lock spring 240 extends between the handle base 40 and detent 210 to bias the detent 210 toward its locking position. As shown in FIGS. 1 and 3, a manually actuatable button 210a of the detent 210 extends through the openings 40c on the left side of the handle base 40 so that a user can manually press the button 210a to move the detent 210 from its locking position into its releasing position.

As shown in FIG. 5, the neck 30 includes a lock closed surface 250 (e.g., a annular notch) that is shaped to accommodate an enlarged shoulder 210b (or other surface of the detent 210) of the detent 210. When the neck 30 is in the closed position, the detent 210 is spring-biased to move into its locked position, which positions the shoulder 210b against or in engagement with the lock closed surface 250, locks the neck 30 in the closed position, and prevents the neck 30 from moving out of the closed position.

As shown in FIGS. 3 and 8, the neck 30 includes a lock open surface 260 (e.g., an annular notch) that is shaped to accommodate the shoulder 210b. When the neck 30 is in the open position, the detent is spring-biased to move the detent 210 into its locking position, which positions the shoulder 210b against or in engagement with the lock open surface 260, locks the neck 30 in the open position, and prevents the neck 30 from moving out of the open position.

When the button 210a is pushed so that the detent 210 moves into its releasing position, the shoulder 210b moves laterally away from the surface 250 or 260, which permits the neck 30 to move between its open and closed positions.

When the neck 30 is in a pivotal position partway between the open and closed positions, the shoulder 210b is spring-biased toward and rides on an annular surface 270 of the neck 30. The surface 270 prevents the detent 210 from moving into its locking position until the neck 30 is pivoted into its open or closed position, at which point the detent 210 can move into its locking position under the bias of the neck lock spring 240.

Hereinafter, opening and closing of the neck 30 is described with reference to FIGS. 1 and 4. When the neck 30 is locked in its closed position (shown in FIG. 1), a user can open the neck 30 by pushing the button 210a, which releases the neck lock 200, causing the neck 30 to automatically pivot into its open position under the biasing force of the neck spring 80. The detent 210 rides along the surface 270 until the neck 30 moves into its open position, at which point the detent 210 automatically moves into its locked position, thereby locking the neck 30 in its open position. The neck spring 80 may therefore facilitate one-handed opening of the neck 30, whereby the user may open the neck 30 with one hand by pressing the button 210a while positioning the user's hand in a way that does not obstruct the pivotal opening patch of the neck 30.

To close the neck 30 when the neck 30 is locked in its open position, the user simultaneously pushes the button 210a and manually pivots the neck 30 out of the open position. The user can then release the button 210a and continue to manually pivot the neck 30 toward and into its closed position against the biasing force of the neck spring 80. Once the neck 30 is in the closed position, the detent 210 automatically returns to its locking position under the bias of the neck lock spring 240, which locks the neck 30 in its closed position.

While the illustrated neck lock 200 utilizes a detent 210, button 210a, and lock surfaces 250, 260, any other suitable type of neck lock could be used without deviating from the scope of the present invention (e.g., the type of locking devices conventionally used with lock-blade sporting knives, the type of neck lock disclosed in U.S. Patent Application Publication No. 2010/0223793 A1, the neck lock contents of which are hereby incorporated by reference).

While the illustrated neck lock 200 includes both lock-open and lock-closed positions, a neck lock 200 according to alternative embodiments of the present invention includes just one of the lock positions (e.g., just a lock-open position or just a lock-closed position). In the illustrated embodiment the same shoulder 210b of the neck lock 200 is used to lock the neck 30 in the open and closed positions. However, according to alternative embodiments, different structures may be used to lock the neck 30 open than are used to lock the neck 30 closed.

In the illustrated embodiment, the detent 210 is movably mounted to the handle base 40, while the surfaces 250, 260 are part of the neck 30. According to an alternative embodiment, the relative positions of the detent 210 and surfaces 250, 260 may be reversed without deviating from the scope of the present invention (e.g., such that the surfaces 250, 260 are disposed on the handle base 40 while the detent 210 is movably mounted to the neck 30).

While the movable connection between the neck 30 and handle base 40 is a pivotal connection in the illustrated embodiment, the movable connection may alternatively be any other type of movable connection (e.g., linear or curved telescopic/sliding connection between the handle base 40 and neck 30) without deviating from the scope of the present invention. For example, the movable connection may comprise a sliding connection, for example as shown in U.S. Pat. No. 7,930,829, the entire contents of which are hereby incorporated by reference. In a sliding connection embodiment, the neck spring 80 may comprise a linear (e.g., coil) spring that urges the neck to slide from its retracted position to an extended position. The neck lock can similarly be modified to accommodate sliding, rather than pivoting, opening and closing of the neck. For example, the same type of detent 210 and locking surfaces 250, 260 may be used in the sliding embodiment. However, the neck surface that connects the surfaces 250, 260 and upon which the detent 210 rides when the neck is between the open and closed positions would be shaped to generally match the opening path of the neck.

As shown in FIG. 8, the neck 30 comprises two halves 30c, 30d that fit together and are held together by the bolt 60 and nut 70. As shown in FIGS. 4 and 8, the neck 30 also includes a textured thumb grip 280 that is sandwiched between the halves 30c, 30d. As shown in FIG. 8, the neck 30 also includes a surface 260 support 290 that is sandwiched between the halves 30c, 30d and defines a portion of the surface 260 to strengthen the surface 260 relative the remainder of the neck 30 and help prevent the surface 260 from deforming or breaking when the neck 30 is locked open and is being used by a user.

The components of the neck 30 and handle base 40 may comprise any suitable materials (e.g., metal, plastic, rubber), and be manufactured using any suitable techniques (e.g., metal stamping, casting, molding, etc.). The outer surfaces of the handle 20 may be provided with a textured and/or elastic surface (e.g., rubberized) to facilitate a user's secure and comfortable grip of the handle 20.

As shown in FIGS. 7-8, the blade holder 300 slides along guide surfaces 30e of the neck halves 30c, 30d. As shown in FIGS. 2 and 8, the blade holder 300 includes a detent/protrusion 310 that fits into a notch 335 (see FIG. 7) of a standard trapezoidal utility blade 330 to help secure the blade 330 to the blade holder 300. When the blade 330 is mounted to the blade holder 300 and the neck halves 30c, 30d are assembled around the blade holder 300, the blade 330 is sandwiched between the blade holder 300 and the neck half 30c so as to lock the blade 330 to the knife 10.

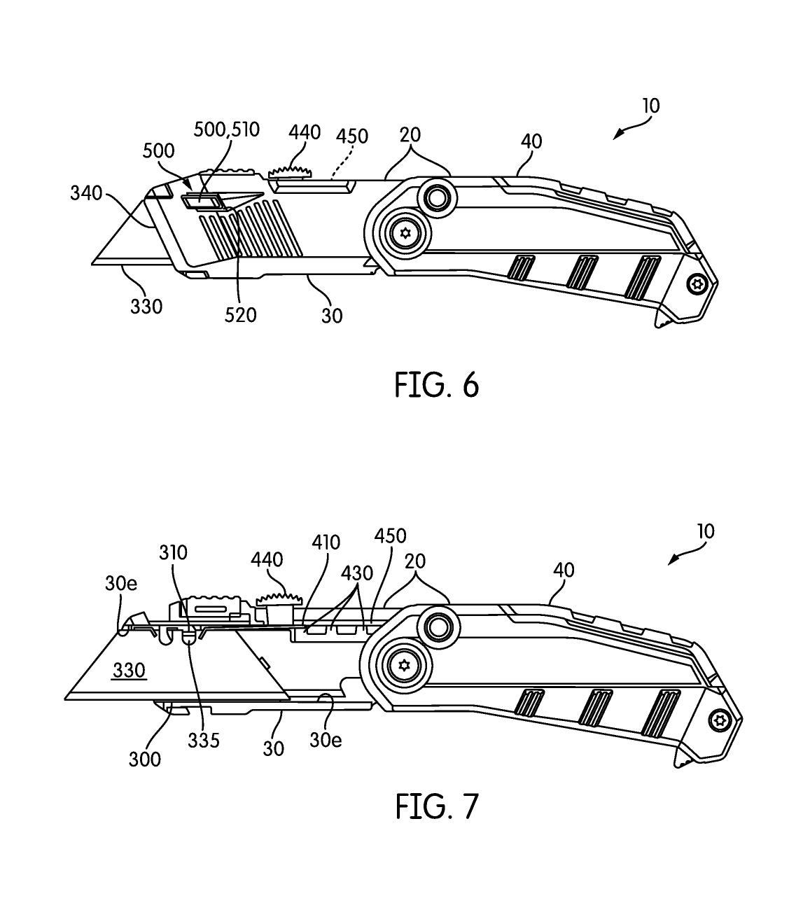

As shown in FIG. 8, the sliding blade holder 300 is slidably/telescopically carried by the neck 30 for movement relative to the neck 30, handle base 40, and handle 20 between a retracted position (see FIGS. 1-5) and one or more extended positions (see FIGS. 6-7). As shown in FIGS. 4-5, when the blade holder 300 is in the retracted position, the trapezoidal utility blade 330 does not extend out of a blade aperture 340 in the front of the neck 30. In the retracted position of the blade holder 300, the cutting edge of the blade 330 is protected by the neck 30. Conversely, as shown in FIG. 6, when the blade holder 300 is in an extended position, a portion of the blade 230 extends out of the aperture 340 so that a portion of the cutting edge of the blade 330 is exposed.

In the illustrated embodiment, the blade holder 300 slides/telescopes linearly relative to the neck 30 between its retracted and extended positions. Alternatively, the blade holder 300 may slide/telescope relative to the neck 30 along a simple or complex curved or curvilinear path without deviating from the scope of the present invention.

In the illustrated embodiment, when the neck 30 is in its open position, the handle base 40 projects away from the neck 30 in a direction that is substantially opposite to a direction that the blade 330 and blade holder 300 move when the blade 330 and blade holder 300 move from their protected/retracted positions to their exposed/extended positions.

As shown in FIG. 8, the knife 10 includes a manually operable slide lock 400 that selectively locks the blade holder 300 in its retracted or one or more extended positions. As shown in FIGS. 2, 7, and 8, the slide lock 400 comprises a detent/protrusion 410 that connects to the blade holder 300 via a leaf spring 420 that upwardly biases the detent 410. As shown in FIGS. 2, 7, and 8, the leaf spring 420 biases the detent 410 toward and into one of a plurality of notches 430 in the neck 30. As shown in FIG. 2, when the detent 410 extends into the rearwardmost notch 430, the blade holder 300 is locked in its retracted position. The remaining notches 430 correspond to increasingly extended locked positions, which expose the blade 330 to varying extents.

The slide lock 400 includes an actuator button 440 that extends upwardly from the spring 420 (see FIGS. 7, 8) and out of the neck 30 through a longitudinal slot 450 in the top of the neck 30 (see FIGS. 1, 2). To use the slide lock 400 and slide the blade holder 300 between its retracted and extended positions, the user presses the button 440 downwardly to disengage the detent 410 from a notch 430. The user then longitudinally pushes or pulls the button 440 to slide the blade holder 300 into the desired extension/retraction position. The user then releases the button 440, which allows the spring 420 to bias the detent 410 back upwardly into the adjacent notch 430, which locks the blade holder 300 in the selected extension/retraction position. The blade holder 300 is locked by the slide lock 400 in the blade holder 300's retracted position in FIGS. 1-5. The blade holder 300 is locked by the slide lock 400 in an extended position of the blade holder 300 in FIGS. 6-7.

While the illustrated embodiment utilizes a top-mounted button 440 for the slide lock 400, a side-mounted button according to an alternative embodiment of the present invention may be used without deviating from the scope of the present invention. Moreover, any alternative type of slide lock may be used without deviating from the scope of the present invention.

In the illustrated embodiment, the blade holder 300, leaf spring 420, and detent 410 are all integrally formed from a bent piece of sheet material (e.g., steel). However, these components may alternatively be separately formed without deviating from the scope of the present invention.

As shown in FIGS. 6 and 8, the knife 10 includes a blade-lock quick-release 500. The quick-release 500 comprises a button 510 that is disposed in the neck 30 and extends outwardly from the neck 30 through a hole 520 in the neck 30. The button 510 is mounted to the neck 30 so as to be spring biased laterally outwardly through the hole 520. As shown in FIG. 8, the release 500 includes an elastically deformable structure 540 (e.g., leaf spring, plastic) extending between the button 510 and where the release 500 is mounted to the neck 30. A shoulder on the button 510 prevents the button 510 from extending through the hole 520 to an extent that the button 510 would fall out of the hole 520. As shown in FIG. 8, when the blade holder 30 is extended, a surface 550 of the release 500 is adjacent to an end of a leaf spring 530 defined by part of the blade holder 300. As shown in FIG. 8, the blade-locking detent 310 is also disposed on the end of the spring 530. To use the quick-release 500 to release the blade 330 from being locked to the knife 10, a user moves the blade holder 300 into its fully extended position and presses the button 520 laterally inwardly, which causes the surface 550 of the release 500 to push the spring 530 laterally, which, in turn, laterally displaces the detent 310, thereby disengaging the detent 310 from the notch 335 in the blade 330. While the user keeps the button 510 pressed, the user can pull the blade 330 out of the aperture 340 in the neck 30 and replace the blade 330 with a new blade 330 or flip the blade 330 around to use the opposite end of the blade's cutting edge. When the blade 330 (or a new blade 330) is slid back into the aperture 340 of the neck 30, the user releases the button 510, which allows the spring 530 to move the detent 310 into engagement with the notch 335 (see FIG. 7), thereby locking the blade 330 to the blade holder 300

Although a specific type of quick release is illustrated, a variety of other types of releasable blade locks may be used without deviating from the scope of the present invention. For example, the halves 30c, 30d of the neck 30 could pivot relative to each other about the axis 50 between closed and open positions. A locking mechanism could selectively hold the neck halves 30c, 30d in their closed position. When in their open position, the blade 330 could be accessed from the side of the knife.

According to various embodiments of the present invention, the quick-release 500 may be omitted. For example, if omitted, the blade 330 could be accessed and replaced by disassembling the neck 30 by unscrewing the bolt 60, as is done in conventional two-half utility knives.

As shown in FIGS. 2, 5, and 8, the handle base 40 includes a surface 40i that abuts the aperture 340 in the neck 30 and/or a front end of the neck 30. The surface 40i prevents the neck 30 from moving into its closed position if the blade 330 extends out of the aperture 340 such that a portion of the blade's cutting edge would be exposed. If a user tried to close the neck 30 while the blade 330 is partially exposed, the user would be unable to move the neck 30 into its closed position, which would, in turn, prevent the neck lock 200 from engaging and locking the neck 30 in the closed position when the blade 330 is partially exposed. Similarly, the surface 40i prevents the blade 330 from moving out of the aperture 340 into an exposed position while the neck 30 is in the closed position. As a result, whenever the neck 30 is locked in its closed position, the blade 330 remains fully protected, such that the spring-assisted opening of the neck 30 will not result in a cutting edge of the blade 330 springing into an exposed position.

Additionally and/or alternatively, the handle base 40 may include a surface that would interfere with a portion of the blade holder 300 when the neck 30 is moved toward the closed position unless the blade holder is in its retracted position. As a result, a user would have to move the blade holder into its retracted position (thereby protecting the blade's cutting edge) before being able to close the neck 30 and lock the neck 30 in the closed position. As a result, the neck 30 would not be able to be closed and locked in the closed position if the blade holder 300 is in an extended position.

By retracting the blade holder 300 and protecting the blade 330 before the neck 30 is pivoted into the closed position, the overall length of the closed knife 10 (as shown in FIG. 1) can be reduced to make the knife 10 more compact when not in use. The combined use of a pivotally-folding handle 20 and a sliding blade holder 300 may result in a compact, versatile knife. As shown in FIG. 4, an overall extended length e of the knife 10 is defined as the largest distance between any two points on the knife 10 (not including any blade) when the neck 30 is in its open position. As shown in FIG. 1, an overall retracted length r of the knife 10 is defined when the neck 30 is in its closed position. The lengths e,r may be along a diagonal (e.g., skewing into the page as shown in FIGS. 1 and 4). According to various embodiments, the length e may be (1) at least 3.5, 4, 4.5, 5, 5.5, 6, 6.5, and/or 7 inches, (2) less than 9, 8.5, 8, 7.5, 7, and/or 6.5 inches, and/or (3) within any range between such upper and lower values (e.g., between 3.5 and 9 inches, between 4 and 7 inches, between 4.5 and 7 inches, and/or about 5.75 or 6.75 inches). According to various embodiments, the length r may be (1) less than 5.5, 5, 4.5, 4.25, 4, 3.75, 3.5, 3.25, and or 3 inches, (2) greater than 1.5, 2, 2.5, 3, 3.5, and/or 4 inches, and/or (3) within any range between any two such values (e.g., between 2.5 and 5.5 inches, between 2.5 and 4.5 inches, about 3 or 4.25 inches).

According to various embodiments, the length e may be (1) at least 15%, 20%, 25%, 30%, 35%, 40%, 45%, 50%, 55%, 60%, 65%, 70%, or 80% larger than the length r, (2) less than 100%, 90%, 80%, 70%, and/or 65% larger than the length r, and/or (3) within any range between any two such values (e.g., length e is between 15% and 100% larger than length r). In one embodiment, the length e is about 61% larger than the length r. Accordingly, moving the neck 30 into its open position makes the handle 20 substantially longer, which may make the handle 20 more comfortable for a user by providing a longitudinally longer support surface for the user's hand when using the knife 10. Conversely, moving the neck 30 into its closed position makes the handle 20 substantially smaller, making the knife 10 easy to store/carry.

As shown in FIGS. 4-5, when the neck 30 is open and the blade 330 is exposed, the cutting edge of the blade 330 and the opening of the channel 40b in the handle base 40 both face downwardly.

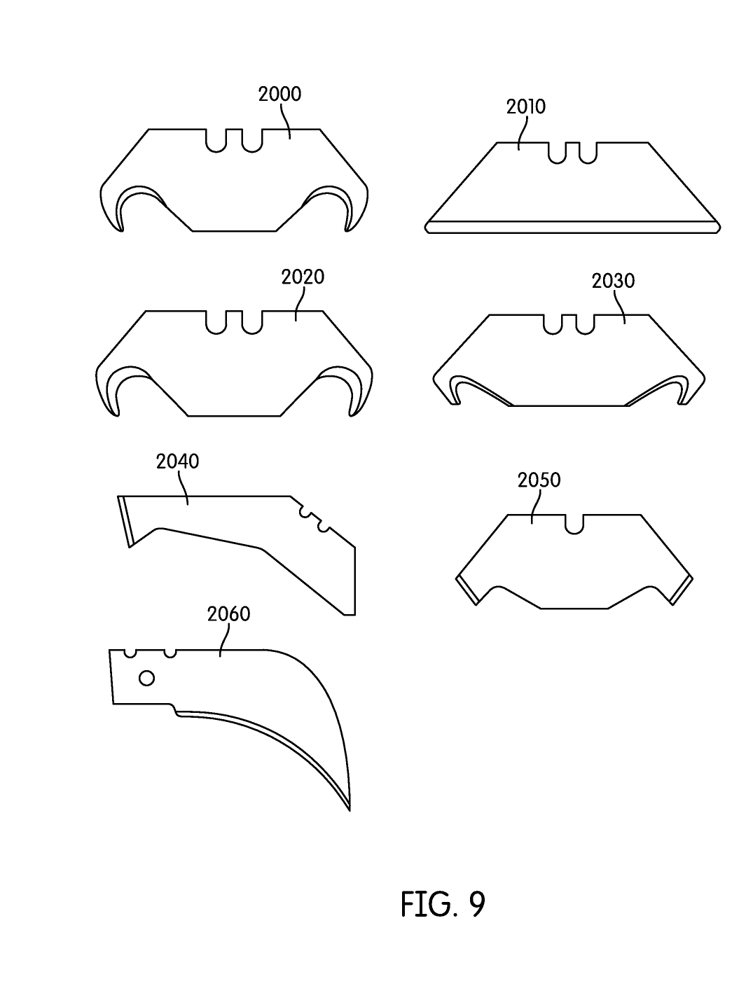

While the illustrated blade 330 comprises a trapezoidal utility blade, a variety of other utility blades may be used with the knife 10 without deviating from the scope of the present invention. According to one or more embodiments of the present invention, the blade may comprise a blade having parallel upper and lower edges, at least one notch in the upper edge, and a cutting edge. The blade may be the trapezoidal blade 330 illustrated, or any other type of utility blade having structure that can be locked to the blade holder 300 and knife 10 in a manner similar to that described above with respect to the blade 330. FIG. 9 illustrates various examples of utility blades 2000, 2010, 2020, 2030, 2040, 2050, 2060 that may be used in connection with the knife 10 without deviating from the scope of the present invention. The use of the blades 2040, 2060 may prevent the blade holder 300 from moving into its fully retracted position and may prevent the handle 20 from fully closing according to various embodiments of the present invention. However, the neck 30, handle 40, and surface 40i may be sized to as to accommodate such blades in the fully retracted blade holder position and the closed handle position. The illustrated standard trapezoidal blades 330, 2010 are about 2⅜ inches long and about ¾ of an inch high.

The foregoing illustrated embodiments are provided to illustrate the structural and functional principles of the present invention and are not intended to be limiting. To the contrary, the principles of the present invention are intended to encompass any and all changes, alterations and/or substitutions within the spirit of the invention.

What is claimed is:

1. A knife comprising:
a handle base;
a neck connected to the handle base for movement relative to the handle base between a closed position and an open position;
a first spring that operatively extends between the handle base and neck to spring-bias the neck toward the neck's open position;
a manually releasable neck lock that releasably locks the neck in closed position, wherein the neck lock is configured such that manually releasing the neck lock while the neck is in the closed position permits the neck spring to move the neck into the neck's open position; and
a utility blade holder slidingly carried by the neck for sliding movement relative to the neck and handle base between a retracted position and an extended position,
wherein the utility blade holder is shaped and configured to carry a utility blade such that movement of the utility blade holder between its extended and retracted positions moves the utility blade relative to the neck and handle base between an exposed position in which a cutting edge of the blade is exposed, and a protected position in which the cutting edge of the blade is protected by the neck.

2. The knife of claim 1, further comprising the utility blade.

3. The knife of claim 2, wherein a surface of the handle base prevents the neck from moving into the closed position unless the utility blade is in the protected position.

4. The knife of claim 2, wherein a surface of the handle base prevents the neck from moving into the closed position while a cutting edge of the utility blade is exposed.

5. The knife of claim 2, wherein a surface of the handle base prevents the blade from moving out of the protected position while the neck is in the closed position.

6. The knife of claim 2, wherein:
the utility blade has a mounting notch formed in a first linear edge and a cutting edge opposite the first linear edge, and
the utility blade substantially has the shape of an isosceles trapezoid, the cutting edge being disposed on a longest edge of the trapezoid.

7. The knife of claim 1, wherein the neck lock is configured to automatically lock the neck in the closed position upon movement of the neck into the closed position.

8. The knife of claim 1, wherein the neck lock comprises:
a detent movably mounted to one of the neck and handle base for movement between a locking position and a releasing position; and
a lock closed surface disposed on the other of the neck and handle base,
wherein, when the neck is in the closed position and the detent is in the locking position, the detent engages the lock closed surface to prevent the neck from moving out of the closed position.

9. The knife of claim 8, wherein:
the neck lock further comprises a second spring that spring biases the detent toward its locking position; and
the detent further comprises a manually actuatable button that may be actuated by a user to move the detent from its locking position to its releasing position against the bias of the second spring, thereby permitting the first spring to move the neck into the neck's open position.

10. The knife of claim 1, wherein the neck lock is configured to automatically lock the neck in the open position upon movement of the neck into the open position, wherein the neck lock is configured to permit manual release of the neck lock while the neck is in the open position to permit a user to move the neck into the closed position.

11. The knife of claim 10, wherein the neck lock comprises:
a detent movably mounted to one of the neck and handle base for movement between a locking position and a releasing position;
a lock open surface disposed on the other of the neck and handle base; and
a second spring that spring biases the detent toward its locking position,
wherein, when the neck is in the open position and the detent is in the locking position, the detent engages the lock open surface to prevent the neck from moving out of the open position, and
wherein, when the detent is in the releasing position, movement of the neck into the neck's open position causes the detent to move into the locking position under the spring bias of the second spring.

12. The knife of claim 1, further comprising a manually operable slide lock that releasably locks the blade holder in the extended position or the retracted position.

13. The knife of claim 1, wherein the neck pivotally connects to the handle base for pivotal movement relative to the handle base between the closed position and the open position.

14. The knife of claim 1, wherein the blade holder is movable between the blade holder's extended and retracted positions while the neck is in the neck's open position.

15. The knife of claim 1, wherein the neck's open position comprises a position in which the neck and handle base together define a longitudinally elongated handle that is shaped and configured for a user to grip the knife during use while the neck is in the open position.

16. The knife of claim 1, wherein a combined length of the handle base and neck when the neck is in the open position is 50%-90% longer than the combined length of the handle base and neck when the neck is in the closed position.

17. The knife of claim 1, wherein a combined length of the handle base and neck when the neck is in the closed position is between 2.5 and 5 inches, and wherein a combined length of the handle base and neck when the neck is in the open position is between 5.5 and 9 inches.

18. A method of using a knife, the knife comprising:
a handle base;
a neck connected to the handle base for movement relative to the handle base between a closed position and an open position;
a first spring that operatively extends between the handle base and neck to spring-bias the neck toward the neck's open position;
a manually releasable neck lock that releasably locks the neck in closed position, wherein the neck lock is configured such that manually releasing the neck lock while the neck is in the closed position permits the first spring to move the neck into the neck's open position;
a utility blade holder slidingly carried by the neck for sliding movement relative to the neck and handle base between a retracted position and an extended position; and
a utility blade carried by the the utility blade holder such that movement of the utility blade holder between its extended and retracted positions moves the utility blade relative to the neck and handle base between an exposed position in which a cutting edge of the blade is exposed, and a protected position in which the cutting edge of the blade is protected by the neck the method comprising:
manually releasing the neck lock of the knife while the neck is in the closed position, whereby said releasing causes the first spring to move the neck into the neck's open position; and
while the neck is in the open position, sliding the utility blade holder from the retracted position to the extended position, thereby moving the utility blade from the protected position to the exposed position.

19. The method of claim 18, further comprising manually releasing the neck lock while the neck is in the open position, and thereafter moving the neck from its open position to its closed position, wherein said movement of the neck into its closed position causes the neck lock to lock the neck in its closed position.

20. The method of claim 18, wherein a surface of the knife prevents the neck from being moved into the closed position unless a cutting edge of the blade is not exposed.
